(19) United States
(12) Patent Application Publication
(10) Pub. No.: US 2015/0189339 A1
(43) Pub. Date: Jul. 2, 2015

(54) DISPLAY OF ABBREVIATED VIDEO CONTENT

(71) Applicant: MOTOROLA MOBILITY LLC, Libertyville, IL (US)

(72) Inventor: Sahil Sood, Chandigarh (IN)

(73) Assignee: MOTOROLA MOBILITY LLC, Libertyville, IL (US)

(21) Appl. No.: 14/143,095

(22) Filed: Dec. 30, 2013

(51) Int. Cl. H04N 21/24; H04N 21/2662; H04N 21/44; H04N 21/81

(52) U.S. Cl. CPC H04N 21/2401; H04N 21/812; H04N 21/2662; H04N 21/44004

(57) ABSTRACT

Disclosed are systems and methods for displaying advertising content to a user requesting to view desired video content, wherein the advertising content may be displayed as a full video advertisement or a corresponding abbreviated video advertisement, and wherein one or both of connection speed and user viewing habits are used to determine in what manner the advertising content is conveyed.

### TECHNICAL FIELD

The present disclosure is generally related to video data processing and, more particularly, to a system and method for deploying long and abbreviated versions of video content to improve user reception of information conveyed by the video content.

### BACKGROUND

While a picture may be worth a thousand words, a moving picture is worth even more. This is no secret, and indeed, the development of motion-picture film and projection technology began very soon after the introduction of traditional still-picture photography. Silent-motion picture technology was introduced in the late 1880's, and by 1930 most motion pictures were accompanied by audio that had been encoded on the film. Film technology continued to advance as successively improved coloring techniques and films were introduced, and by mid-century, most movies were life-like in their movement, sound, and coloring.

However, the use of motion picture film incurred a financial penalty for purchase and development and also created delays due to film processing. The cost and delay did not substantially hinder the traditional movie industry, but these burdens were troublesome for producers of high-frequency, time-sensitive content, such as televised news. In part to solve these problems, Charles Ginsburg introduced the first video-tape recorder in 1951. Over time, his analog video data were replaced by digital video data, and eventually the video tape itself became obsolete, and it became common to store digital video data in solid-state memory or on a magnetic or optical disc.

All of these advances matured to produce today's culture of personalized video, wherein people of ordinary means all over the world have access to digital video technology and can cheaply and quickly produce personalized video content. Contemporaneously, the Internet has blossomed, providing a new platform for sharing this abundance of video content. However, the production, hosting, and transmission of digital video requires some amount of cash flow, arising from the need to compensate personnel, to purchase and to maintain storage and processing hardware, to lease bandwidth, and so on.

To monetize the sharing of video content, an advertising model similar to that used in broadcast media has arisen. In particular, for sites that do not require video consumers to pay for video content, the operating costs and profits are provided by advertisers that pay money to have their advertisements displayed to video consumers. While the questions of which videos to use and how much to pay have provided ample distraction for video hosts and advertisers, the primary challenge for both remains how to get the consumer to actually watch the advertising material.

It will be appreciated that this Background section represents the observations of the inventors, which are provided simply as a research guide to the reader. As such, nothing in this Background section is intended to represent, or to fully describe, prior art.

### BRIEF DESCRIPTION OF THE SEVERAL VIEWS OF THE DRAWINGS

While the appended claims set forth the features of the present techniques with particularity, these techniques, together with their objects and advantages, may be best understood from the following detailed description taken in conjunction with the accompanying drawings of which:

FIG. 1 is a logical diagram of a device with respect to which embodiments of the disclosed principles may be implemented;

FIG. 2 is a schematic diagram of a network environment within which embodiments of the disclosed principles may be implemented;

FIG. 3 is a flowchart illustrating a process for determining whether to replace a full video advertisement with a corresponding abbreviated video advertisement in accordance with an embodiment of the disclosed principles; and

FIG. 4 is a flowchart illustrating a process for accommodating a user's minimizing or otherwise making invisible the full video advertisement in accordance with an embodiment of the disclosed principles.

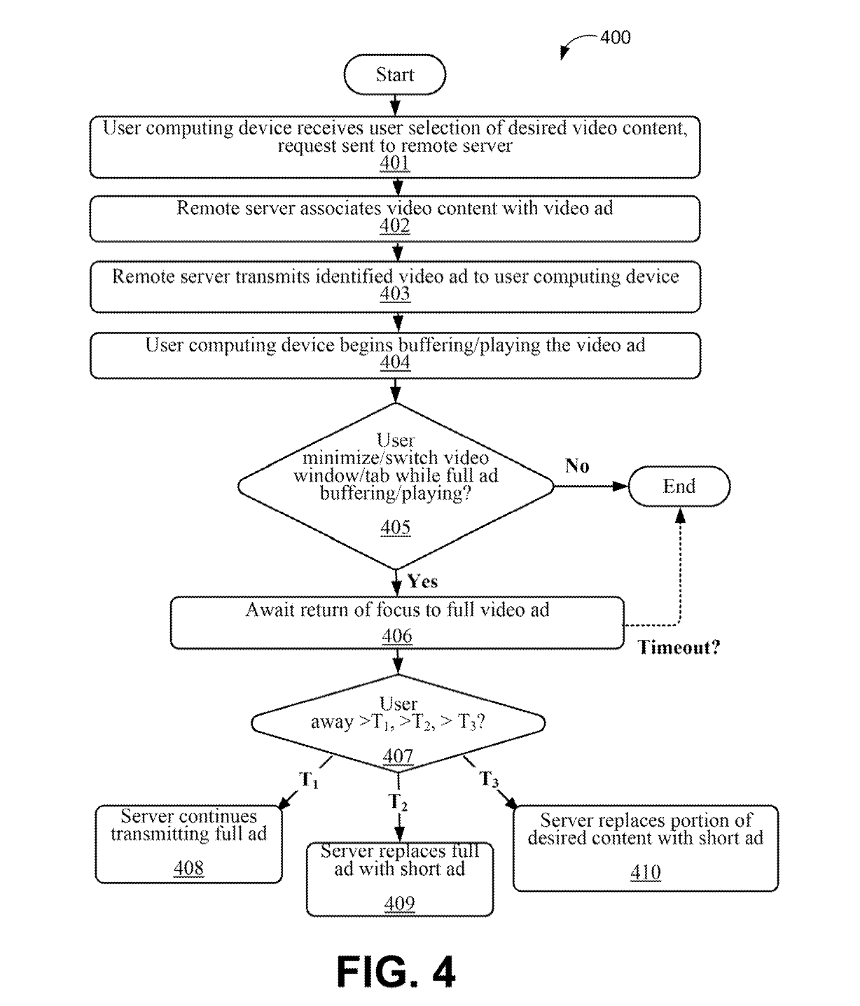

### DETAILED DESCRIPTION

Turning to the drawings, wherein like reference numerals refer to like elements, techniques of the present disclosure are illustrated as being implemented in a suitable environment. The following description is based on embodiments of the disclosed principles and should not be taken as limiting the claims with regard to alternative embodiments that are not explicitly described herein.

Before providing a detailed discussion of the Figures, a brief overview will be given to guide the reader. A number of popular options exist for sharing and viewing user video content. For example, sites such as YOUTUBE™ allow users to upload, view, and share videos such as movie clips, TV clips, music videos, amateur content such as video blogging, short original videos, and educational videos. However, as noted above, a user may be shown advertising content before certain videos can be buffered and played. In particular, the user is typically forced to wait for the advertising video to be buffered before he is allowed to watch the desired video. When the network speed is slow or when a user's connection is slow, this buffering step can cause a substantial delay.

In an aspect of the disclosed teachings, each video advertisement, which may be, for example, a video of 30 seconds or so in length, is associated with a short video banner version that is a static image or a shorter video, e.g., of 3 seconds in length. The video banner may be a different image or video entirely or may be an image or video taken from the full video advertisement. For example, the video banner may act as a short summary of the full advertisement. Thus, if a movie trailer is 30 seconds long, then the video banner may show a static image poster of the movie with release date, cast, genre, etc. Alternatively, the video banner may be an animated short poster, e.g., of 2 or 3 seconds, showing relevant information.

As noted above, a user device can have a low download speed for any number of reasons, with the result that a 30-second advertisement may actually take more than 30 seconds to buffer. This may cause the user to experience an additional delay (until the desired video is shown) on a connection that is already slow. However, in an aspect of the disclosed principles, the server providing the video content is configured to detect the slow Internet connection employed by the user and, in response, to replace the full video advertisement with a shorter video banner. The shorter video banner may be already stored at the server or may be provided by the content provider.

Thus, for example, it may be that during downloading of a 30-second advertisement, 25 seconds in real time have passed, but only an initial 10 seconds of the full advertisement have been buffered and shown to the user due to a slow connection. In an embodiment, for the remaining 5 seconds of real time, the server may replace the full video advertisement with the shorter video banner. More generally, when a time threshold is reached during download and the advertisement content is still buffered less than an actual buffered time threshold, the server may replace the full video advertisement with the shorter video banner.

This principle is also applicable in the context of fast Internet connections, e.g., where the buffer time for a 30-second advertisement is less than 30 seconds, and the advertisement is displayed smoothly without any need to stop for buffering. Even in this case, some users will open multiple video windows and let one or more advertisements run while the user has either minimized the browser or switched to a different tab or window. This is of course a loss to the advertisers since the advertisements are running, but the user is not watching. While the advertisement could conceivably be paused to prevent the user from avoiding the advertisement content by minimizing the browser or switching to a different tab, this approach risks annoying the user by simply forcing them to watch the entire advertisement.

Accordingly, the server is be configured, in an embodiment, to detect that the user has minimized the browser or switched to a different tab or window for all or part of the full advertisement. If the user returns after a relatively short period such as 10 seconds, then the full advertisement continues to play, because the user may not actually want to avoid the advertisement, and there is still a substantial portion of the advertisement remaining to be displayed. If, however, the user returns after most of the full advertisement has been displayed, e.g., after 25 seconds, then the user has already missed substantially the entire advertisement. Accordingly, in this case the server may, upon detecting that the user has returned after the longer threshold period, replace the full advertisement remaining time period with the shorter video banner for the advertisement. Finally, it is possible that the user may return only after the advertisement has ended and the actual desired video content is being played, e.g., after a delay of 35 seconds. In this situation, the server is configured to replace a small portion (e.g., 2 to 3 seconds) of the desired video with the static video banner. This small portion may be played immediately after the user returns to the window or tab of interest or may be played after a delay. The added content may either supplant or delay the corresponding portion of the desired video content.

The various time thresholds may be referenced to either real time or buffered time. With respect to buffered-time thresholds, in an embodiment, if a buffered time substantially equal to but less than the full video advertisement time has passed during the playing of the full advertisement (e.g., 90%), and a much longer period of real time has passed (e.g., substantially twice the buffered time), then the server may replace the remaining advertisement time or real time with the video banner.

Conversely, if, when the user returns, only a small portion of the advertisement has been buffered and displayed (e.g., 30% or 10 seconds), and much more real time has passed (e.g., one minute), then a different approach is used in an embodiment. In particular, the server may be configured to run a check to detect a slow Internet connection and to run the banner advertisement in place of the full video advertisement if a slow connection is detected.

It is possible that when a user returns, enough time has passed, the full video advertisement has been buffered and played, and the playing of the desired video has already begun. In an embodiment addressing this scenario, the server is configured to replace or displace desired video content with the video banner before continuing with the desired video once again.

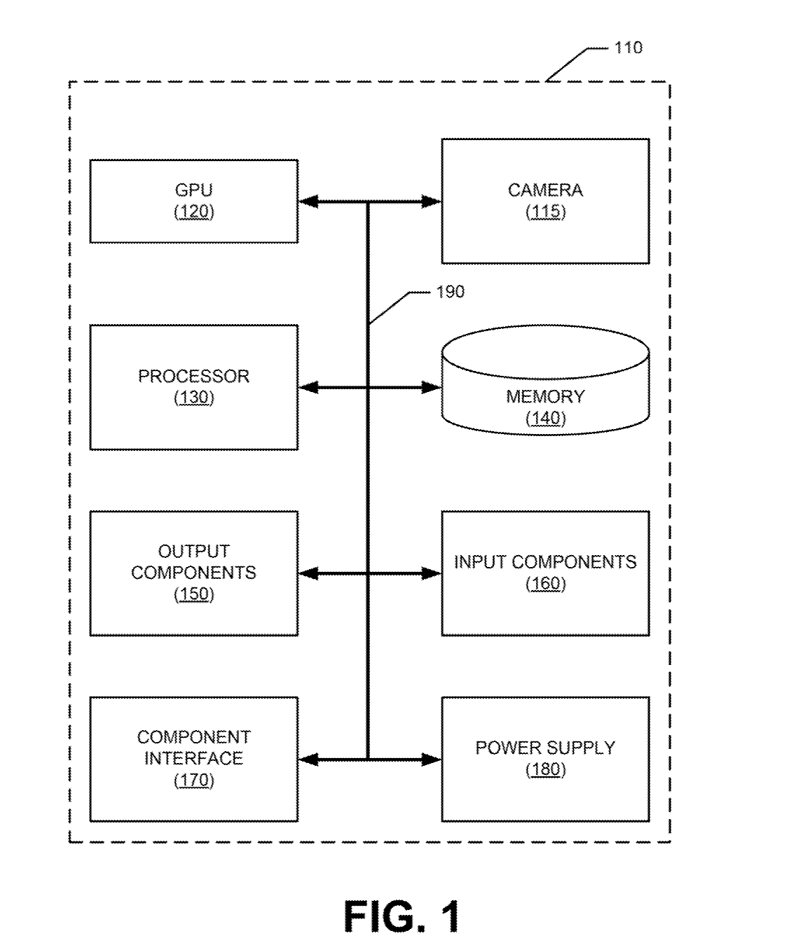

With this general overview in mind, various details and features of the disclosed embodiments are described. The disclosed techniques may be implemented similarly whether the user device is a mobile device such as a smart phone, a portable device such as a laptop, or a stationary device such as a desktop personal computer. While all possible user devices are not described, a mobile electronic device is shown by way of example in FIG. 1.

The illustrated user device 110 includes several exemplary internal components. Internal components of the user device 110 may include a camera 115, a graphics processing unit (“GPU”) 120, a processor 130, a memory 140, one or more output components 150, and one or more input components 160. The processor 130 can be any of a microprocessor, microcomputer, application-specific integrated circuit, or the like. For example, the processor 130 can be implemented by one or more microprocessors or controllers from any desired family or manufacturer. Similarly, the memory 140 may reside on the same integrated circuit as the processor 130.

The memory 140 may be accessed via a network, e.g., via cloud-based storage. The memory 140 may include a random-access memory (i.e., synchronous dynamic random-access memory, dynamic random-access memory, RAMBUS™ dynamic random-access memory, or any other type of random-access memory device). The memory 140 may include a read-only memory (i.e., a hard drive, flash memory, or any other desired type of memory device).

The information that is stored by the memory 140 can include code associated with one or more operating systems or applications as well as informational data, e.g., program parameters, process data, etc. The operating system and applications are typically implemented via executable instructions stored in a non-transitory computer-readable medium (e.g., memory 140) to control basic functions of the electronic device 110. Such functions may include, for example, interaction among various internal components, control of the camera 115 or the component interface 170, and storage and retrieval of applications and data to and from the memory 140.

The device 110 may also include a component interface 170 to provide a direct connection to auxiliary components or accessories and a power supply 180, such as a battery, for providing power to the device components. In an embodiment, all or some of the internal components communicate with one another by way of one or more internal communication links 190, such as an internal bus.

Further with respect to the applications, these typically utilize the operating system to provide more specific functionality, such as file-system service and handling of protected and unprotected data stored in the memory 140. Although many applications may govern standard or required functionality of the user device 110, in many cases applications govern optional or specialized functionality, which can be provided, in some cases, by third-party vendors unrelated to the device manufacturer.

Finally, with respect to informational data, e.g., program parameters and process data, this non-executable information can be referenced, manipulated, or written by the operating system or by an application. Such informational data can include, for example, data that are preprogrammed into the device 110 during manufacture, data that are created by the device 110, or any of a variety of types of information uploaded to, downloaded from, or otherwise accessed at, servers or other devices with which the device 110 is in communication during its ongoing operation.

In an embodiment, the device 110 is programmed such that the processor 130 and memory 140 interact with the other components of the device 110 to perform a variety of functions. The processor 130 may include or implement various modules and execute programs for initiating different activities such as launching an application, transferring data, and toggling through various graphical user interface objects (e.g., toggling through various icons that are linked to executable applications).

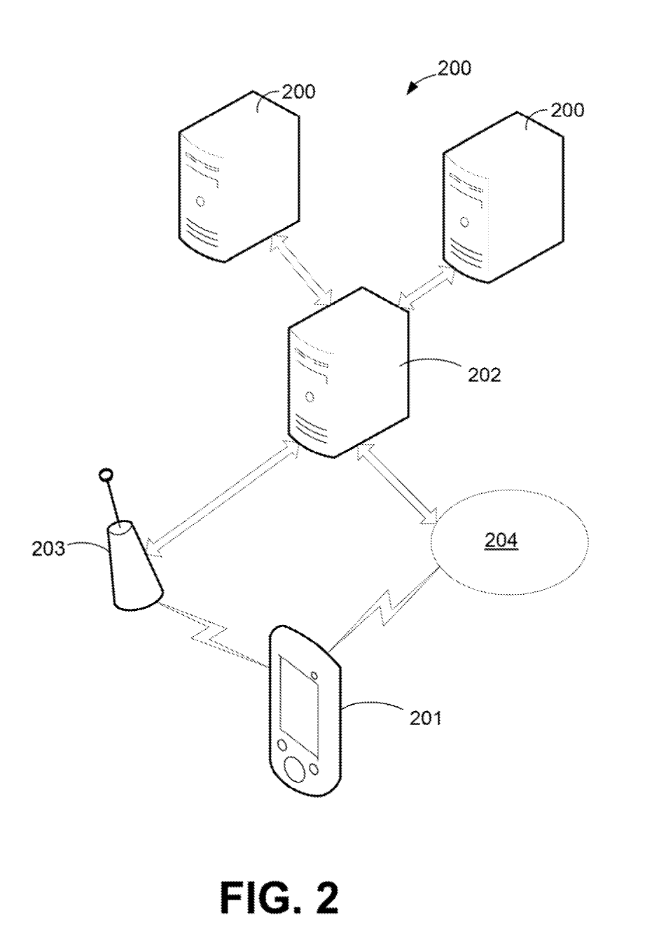

Whether an implementation of the disclosed principles employs a mobile device such as that illustrated in FIG. 1 or instead employs another type of computing device, a remote server is used to provide video data to the device. The network diagram of FIG. 2 illustrates an exemplary networking architecture and environment 200 within which embodiments of the disclosed principles may be implemented. In the illustrated embodiment, a mobile device 201 associated with a user is linked to a server 202 to request desired video content.

The mobile device 201 may be linked to the server 202 via a wireless access point 203 and any intervening network or networks (not shown) such as the Internet or one or more other networks. Alternatively, the mobile device 201 may be linked to the server 202 via a cellular network 204 and any intervening network or networks as discussed above.

In an embodiment, the server 202 is in turn linked to one or more secondary servers 205, 206. The server 202 may utilize the secondary servers 205, 206 in order to obtain video content such as the desired video content, a full-length video advertisement, and a video banner advertisement (referred to as an abbreviated advertisement) associated with the full-length video. For example, the server 202 may store the desired video but may download the full-length and abbreviated advertisements from the secondary servers 205, 206. Alternatively, the server 202 may use the secondary servers 205, 206 to obtain all of the desired video content, the full-length video advertisement, and the abbreviated advertisement.

While the servers 202, 205, 206 may have access to high upload bandwidths, the mobile device 201 may nonetheless experience a substantially lower download bandwidth. In particular, the download bandwidth experienced by the device 201 may be limited by any of the following: a limitation at the device 201 itself, a limitation in either the access point 203 or the cellular network 204, or a limitation at one or more of the intervening networks (not shown).

As noted above, a slower download speed is one factor, among several, that may be evaluated to determine the manner in which video advertisements and abbreviated advertisements are shown in conjunction with desired video content. In overview, the server 202 provides content to the user computing device (e.g., device 201) using a technique that accommodates device download bandwidth while ensuring that at least the abbreviated advertisement, and in some cases the full video advertisement, is displayed to the user in the currently active window. In this way, advertisers can be more confident that their product or service information is reaching each user viewing the sponsored desired video content.

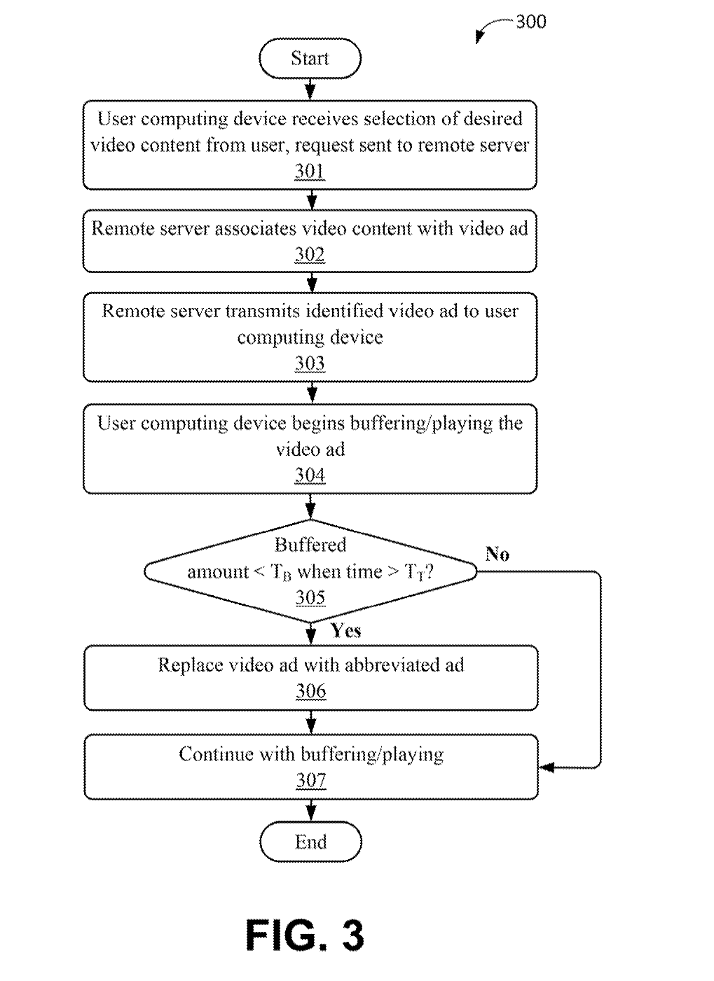

While the foregoing principles may be applied in a variety of ways, an exemplary decision process 300 is shown in the flowchart of FIG. 3. Although this example assumes an architecture that is similar to that shown herein, those of skill in the art will appreciate that changes in the architecture and corresponding changes in the process flow may be made without departing from the disclosed principles.

The process illustration assumes that any prerequisites of the recited steps are met (e.g., that user computing device is powered on and connected or connectable to the remote server). At stage 301 of the process 300, the user computing device receives a selection from a user identifying desired video content and transmits a request for the desired video content to the remote server.

The remote server associates the desired video content with a video advertisement at stage 302 of the process 300 and transmits the video advertisement, e.g., by streaming or otherwise, to the user computing device at stage 303. At stage 304, the user computing device begins buffering and, when appropriate based on the state of buffering, playing the video advertisement.

At stage 305, the remote server determines whether the buffered amount of the video advertisement is less than a buffer threshold T_{B} when the elapsed real time since the download began exceeds a time threshold T_{T}. If it is found at stage 305 that the buffered amount is less than the buffer threshold when the elapsed real time exceeds the time threshold, then the remote server replaces the video advertisement with an abbreviated advertisement at stage 306. Otherwise, the remote server continues to stream the video advertisement to the user computing device at stage 307.

As noted above, the selective application of abbreviated advertisement content is also useful even where connection speed is not necessarily problematic. As such, in an embodiment, the content server further monitors the state of the video advertisement buffering and the state of the window associated with the video advertisement and desired content in order to improve user viewing of information associated with the video advertisement.

At stage 401 of the process 400, the user computing device receives a selection from a user identifying desired video content and transmits a request for the desired video content to the remote server.

The remote server associates the desired video content with a video advertisement at stage 402 of the process 400 and transmits the video advertisement, e.g., by streaming or otherwise, to the user computing device at stage 403. At stage 404, the user computing device begins buffering and, when appropriate based on the state of buffering, playing the video advertisement. It will be appreciated that stages 401, 402, 403, 404 may be separately executed for the process 400 or may have already been executed pursuant to process 300 discussed above.

At stage 405, the remote server determines whether the user has minimized the window in which the video advertisement is being buffered and played, or switched to another tab or window, while the buffering and playing of the video advertisement is ongoing. If not, the process 400 exits. However, if it is determined by the server that the user has minimized the window, or switched the tab or window in which the video advertisement is being buffered and played, then the process 400 flows to stage 406. At stage 406, the server waits until the user has returned to the tab or window in which the video advertisement is being buffered and played. Optionally, if a timeout limit is reached before the user returns, then the process 400 exits.

Once the user is determined to have returned, the process 400 flows to stage 407, wherein the server determines whether the user has returned after a first threshold buffer value T₁, a second threshold buffer value T₂, or a third threshold buffer value T₃. The thresholds T₁, T₂, T₃ may be percentages, times, or other measures that reflect an amount of the video advertisement that has been buffered or played or the amount of time that the user has been away from the window or tab. In an embodiment, the thresholds reflect actual user time away, and in a further embodiment, the thresholds with respect to a 30-second advertisement are set as T₁=10 sec., T₂=25 sec., and T₃>35 sec.

In the case of meeting the first threshold T₁ but not the second T₂, it may be assumed that the user is not intentionally avoiding the advertisement and moreover has not missed a substantial amount of the advertisement. In the case of meeting the first threshold T₁ and the second T₂, it may be assumed that the user has already missed a substantial part of the advertisement. In the event that the circumstances meet the third threshold T₃, it may be assumed that the user has missed the advertisement entirely.

Thus, from stage 407, the process 400 flows to one of stages 408, 409, and 410 depending upon which thresholds are met. In particular, if the first threshold T₁ is met, but the second T₂ is not, then the process 400 flows to stage 408, wherein the server continues transmitting the full advertisement. Similarly, if the first threshold T₁ and second T₂ are met, but the third threshold T₃ is not, then the process 400 flows to stage 409, wherein the server replaces the full advertisement remaining time period with the abbreviated advertisement content, such that at least the important details of the video advertisement may be conveyed, for example. Finally, if the third threshold T₃ is met, e.g., such that the advertisement has already passed and the actual desired content is being played, then the process 400 flows to stage 410, wherein the server replaces a short portion of the desired content, e.g., 2 to 3 seconds, with the abbreviated advertisement. This approach may minimize user annoyance while ensuring that at least some of the advertisement content is conveyed to the user. From any of stages 408, 409, and 410, the process 400 may exit.

As noted above, the various thresholds employed in processes 300 and 400 may be real-time thresholds, buffered-time thresholds, time or buffer percentage thresholds, or otherwise. The described techniques employ the thresholds to differentiate different scenarios with respect to user viewing of advertisement material. In this way, user exposure to important aspects of the advertisement is improved, whether by playing the full video advertisement or the abbreviated advertisement.

It will be appreciated that the disclosed principles provide enhanced value to providers of video content who may support operations through the provision of advertising material provided along with desired video content. However, in view of the many possible embodiments to which the principles of the present discussion may be applied, it should be recognized that the embodiments described herein with respect to the drawing figures are meant to be illustrative only and should not be taken as limiting the scope of the claims. Therefore, the techniques as described herein contemplate all such embodiments as may come within the scope of the following claims and equivalents thereof.

We claim:

1. A method for providing desired video content to a user in conjunction with advertising information, wherein the advertising information is embodied in a full-length video advertisement and in an abbreviated video advertisement that is substantially shorter than the full-length video advertisement, the method comprising:
receiving at a server a request to send the desired content to a user computing device associated with the user and responsively initiating transmission of the full-length video advertisement and the desired content to the user computing device;
at the server detecting a buffer status of the full-length video advertisement, the buffer status being indicative of an amount of the full-length video advertisement that has been buffered for display at the user computing device; and
determining at the server whether to initiate transmission of the abbreviated video advertisement to the user computing device based on the detected buffer status.

2. The method of claim 1 wherein the buffer status identifies a percentage of the full-length video advertisement that has been buffered.

3. The method of claim 1 wherein determining at the server whether to initiate transmission of the abbreviated video advertisement further comprises determining whether the buffer status is less than a buffer-status threshold when an elapsed time since the start of buffering the full-length video advertisement exceeds a time threshold.

4. The method of claim 3 further comprising initiating transmission of the abbreviated video advertisement to be buffered and displayed in lieu of the full-length video advertisement when the buffer status is less than the buffer-status threshold and the elapsed time exceeds the time threshold.

5. The method of claim 3 wherein determining at the server whether to initiate transmission of the abbreviated video advertisement comprises determining not to initiate transmission of the abbreviated video advertisement when the buffer status is greater than the buffer-status threshold and the elapsed time exceeds the time threshold.

6. The method of claim 1 wherein determining at the server whether to initiate transmission of the abbreviated video advertisement further comprises determining whether a window for display of the advertising material has been made not visible to the user and determining, if the window has been made not visible to the user, how long the window has been not visible to the user.

7. The method of claim 6:
wherein the window for display of the advertising material has been made not visible to the user; and
wherein determining at the server whether to initiate transmission of the abbreviated video advertisement comprises determining not to initiate transmission of the abbreviated video advertisement when the window has been not visible to the user for less than a first threshold period.

8. The method of claim 6:
wherein the window for display of the advertising material has been made not visible to the user; and
wherein determining at the server whether to initiate transmission of the abbreviated video advertisement comprises determining to initiate transmission of the abbreviated video advertisement to replace the full video advertisement when the window has been not visible to the user for more than the first threshold period but less than a second threshold period.

9. The method of claim 6:
wherein the window for display of the advertising material has been made not visible to the user; and
wherein determining at the server whether to initiate transmission of the abbreviated video advertisement comprises determining to initiate transmission of the abbreviated video advertisement to replace a portion of the desired content when the window has been not visible to the user for more than a third threshold period that exceeds the first threshold period and the second threshold period.

10. A system for providing desired video content to a user in conjunction with advertising information, wherein the advertising information is embodied in a full-length video advertisement and an abbreviated video advertisement that is substantially shorter than the full-length video advertisement, the system comprising:
memory media containing desired video content, a full video advertisement, and an abbreviated video advertisement corresponding to the full video ad; and
a server configured to initiate transmission of the full-length video advertisement and the desired content to a user computing device upon receiving from the user computing device a request to send the desired content to the user computing device, the server being further configured to detect a buffer status of the full-length video advertisement, the buffer status being indicative of an amount of the full-length video advertisement that has been buffered for display at the user computing device, and to determine whether to initiate transmission of the abbreviated video advertisement to the user computing device based on the detected buffer status.

11. The system of claim 10 wherein the buffer status identifies a percentage of the full-length video advertisement that has been buffered.

12. The system of claim 10 wherein the server is configured to determine whether to initiate transmission of the abbreviated video advertisement by determining whether the buffer status is less than a buffer-status threshold when an elapsed time since the start of buffering the full-length video advertisement exceeds a time threshold.

13. The system of claim 12 wherein the server is further configured to initiate transmission of the abbreviated video advertisement to be buffered and displayed in lieu of the full-length video advertisement when the buffer status is less than the buffer-status threshold and the elapsed time exceeds the time threshold.

14. The system of claim 12 wherein the server is further configured to determine not to initiate transmission of the abbreviated video advertisement when the buffer status is greater than the buffer-status threshold and the elapsed time exceeds the time threshold.

15. The system of claim 10 wherein the server is further configured to determine whether a window for display of the advertising material has been made not visible to the user, and to determine, if the window has been made not visible to the user, how long the window has been not visible to the user.

16. The system of claim 15 wherein the server is further configured to not initiate transmission of the abbreviated video advertisement when the window has been not visible to the user for less than a first threshold period.

17. The system of claim 15 wherein the server is further configured to initiate transmission of the abbreviated video advertisement to replace the full video advertisement when the window has been not visible to the user for more than a first threshold period but less than a second threshold period.

18. The system of claim 15 wherein the server is further configured to initiate transmission of the abbreviated video advertisement to replace a portion of the desired content when the window has been not visible to the user for more than a third threshold period that exceeds a first threshold period and a second threshold period.

19. A method of selecting one of a full video advertisement and an abbreviated video advertisement for display to a user of a computing device in conjunction with a display of desired video content, the abbreviated video advertisement corresponding to the full video advertisement, the method comprising:
initiating buffering of the full video ad;
determining whether the buffering of the full video advertisement indicates a slow connection with respect to the computing device; and
initiating buffering of the abbreviated video advertisement to replace the full video advertisement when it is determined that the buffering of the full video advertisement indicates a slow connection with respect to the computing device.

20. The method of claim 19 further comprising:
determining whether the user of the computing device has not seen a first portion, a second portion greater than the first portion, or a third portion greater than the first and second portions of the full video ad;
initiating buffering of the abbreviated video advertisement to replace the full video advertisement when the user has not seen a portion of the full video advertisement that is greater than the first portion but less than the second portion; and
initiating buffering of the abbreviated video advertisement to replace a portion of the desired video content when the user has not seen a portion of the full video advertisement that is greater than the third portion.
